(19) United States
(12) Patent Application Publication
(10) Pub. No.: US 2005/0165885 A1
(43) Pub. Date: Jul. 28, 2005

(54) Method and apparatus for forwarding data packets addressed to a cluster servers

(76) Inventor: Isaac Wong, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/746,750

(22) Filed: Dec. 24, 2003

(51) Int. Cl. G06F 15/16

(52) U.S. Cl. 709/201; 709/245

(57) ABSTRACT

Methods and apparatus are disclosed for forwarding a data packet addressed to a cluster of servers. According to one disclosed method, when a connection request is received from a client, a connection identifier is formed according to the connection request. The connection request is forwarded to a first-identified server in the cluster of servers. The connection identifier is associated with a responding server in the cluster of servers. Subsequent traffic received from the client associated with the connection identifier is forwarded to the responding server associated with the connection identifier.

### BACKGROUND

The “client-server model” is a transactional model used by many computers. The client-server model recognizes that certain computers provide information or services. These providers are called servers. The client-server model further recognizes that certain computers are consumers of information or services provided by a server. These consuming computers are called clients. In order to engage in a client-sever transaction, both the server and the client typically communicate over a computer network.

Typically, a client-server transaction, or “session”, is initiated by a client attached to a computer network. The client initiates the transaction by conveying a request for service to the server. Accordingly, the server responds to the request either by performing some service or by providing information to the client.

Although this client-server model sounds simple enough, there are sophisticated processes involved at every level. For example, a client and a server typically communicate with each other using a “connection”. Accordingly, the client typically initiates a client-server session by sending a “connection request” to the server. The connection request typically conforms to a communications protocol. A communications protocol is a message definition that governs communications over the computer network that connects the client to the server.

One popular communications protocol is known as TCP/IP. TCP stands for Transport Control Protocol, a protocol that governs end-to-end communication in a computer network. Many computer networks are packet-based, meaning that information flowing on a computer network is encapsulated into discrete units referred to as data packets. Data packets may comprise the equivalent of a few hundred characters of information. A data packet comprises user information as well as protocol information that is used by TCP/IP or other network protocols to manage the delivery of the data packet through the computer network. The “IP” part of TCP/IP refers to Internet Protocol, a lower-level protocol used for addressing and routing of data packets through a computer network. One example of a computer network, the Internet, comprises a large collection of interconnected computers that are capable of communicating with each other by exchanging TCP/IP data packets.

The TCP/IP protocol provides message definitions that can be used to support a client-server session. These message definitions can be used to establish a “TCP connection”. Once a TCP connection between a client and server has been established, both the client and server can send and receive information over the connection. The TCP connection can be terminated when the client and the server agree to end their client-server session.

Computers that are attached to a computer network are sometimes referred to as “nodes.” Each computer on a computer network is usually associated with a logical address. At a very rudimentary level, data pertaining to a connection is carried by data packets that include protocol information. Included in this protocol information is a logical address of a source node and a logical address of a destination node. Sometimes, the protocol information includes a port identifier for either or both of the source and destination nodes. A port can be thought of as a logical channel that is maintained on either or both of the source and destination nodes.

Each connection between a client and a server is generally identified by a connection identifier. Typically, a connection identifier includes a logical address of a source node and a logical address of a destination node as included in the data packets used to support conveyance of data pertaining to the connection. Often, the connection identifier also includes a port identifier for the source and destination nodes. When data packets flow from the client to the server, the client acts as a source of data packets, and the server acts as a destination of data packets. Conversely, when data packets flow from the server to the client, the server acts as a source of packets, and the client acts as a destination of packets.

Modernly, servers can accommodate multiple request for service from one or more clients. Even in light of the fact that modern computers are high-performance processors, a single server can become overloaded as the total quantity of essentially simultaneous requests for service rises. In order to support larger quantities of simultaneous requests from one or more clients, a “server” can comprises a cluster of servers that collectively share server duties. A client generally does not need to know whether a “server” is a single server or a cluster of servers that cooperate to provide requested services.

A client typically initiates a client-server session by sending a connection request to a server. The connection request is normally directed to the server using the servers logical address. In the case where a server is actually a cluster of servers, a single logical address is still used to direct a connection request to the cluster. Typically, a single server in the cluster, known as a “doorkeeper”, processes each connection request that arrives at the server cluster. When the doorkeeper server receives a connection request from a client, the doorkeeper server may either process the request directly or it may delegate the request to a different server in the cluster. Such delegation of requests is often referred to as load-balancing.

When a doorkeeper delegates a client request to another server in the cluster, the request is actually forwarded to a support server using that support server's logical address. The support server processes the request and responds back to the client. The support server is generally configured to respond to the client using the logical address associated with the doorkeeper. Noting that a connection identifier includes the logical address of a source node for a data packet, the client would not be able to associate the response from the support server if the support server did not adopt the doorkeeper's logical address when it conveys a response to the client. As long as a connection remains between a client and a server in the cluster, the doorkeeper must process every incoming data packet pertaining to the connection. When the doorkeeper is actually processing the client's request, it is apparent that it must process every data packet pertaining to the connection. When the doorkeeper has delegated the client's request to a support server, it must act as a repeater between the client and the support server. The doorkeeper must forward to the support server data packets pertaining to the connection because the client is only aware of a single logical address—that of the doorkeeper.

### SUMMARY

Methods and apparatus are disclosed for forwarding a data packet addressed to a cluster of servers. According to one disclosed method, when a connection request is received from a client, a connection identifier is formed according to the connection request. The connection request is forwarded to a first-identified server in the cluster of servers. The connection identifier is associated with a responding server in the cluster of servers. Subsequent traffic received from the client associated with the connection identifier is forwarded to the responding server associated with the connection identifier.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram of a representative embodiment of a method for forwarding a data packet to a cluster of servers;

FIG. 2 is a block diagram that illustrates one example application of one example method for forwarding a data packet to a cluster of servers;

FIG. 3 is a pictorial diagram of a representative embodiment of a routing table;

FIG. 4 is a flow diagram that depicts two alternative methods for receiving a connection request;

FIG. 5 is a pictorial diagram that illustrates an example nested structure for a connection request conforming to the TCP/IP protocol;

FIG. 6 is a flow diagram of a representative embodiment of a method for creating a connection identifier;

FIG. 7 is a flow diagram of a representative example method for forwarding a connection request to a first-identified server;

FIG. 8 is a flow diagram of a representative embodiment of a method for associating a connection identifier with a responding server;

FIG. 9 is a flow diagram of a representative embodiment of a method for forwarding subsequent traffic to a responding server;

FIG. 10 is a block diagram of a representative embodiment of a data packet forwarding apparatus;

FIG. 11 is a block diagram of one alternative example embodiment of a connection manager;

FIG. 12 is a block diagram of an exemplary embodiment of a packet network switch;

FIG. 13 is a data flow diagram that describes the interaction of functional modules according to one representative embodiment of a packet network switch;

FIG. 14 is a pictorial diagram of a representative embodiment of an association table;

FIG. 15 is a data flow diagram that describes the operation of one alternative embodiment of a packet switch as it receives a connection request; and

FIG. 16 is a data flow diagram that describes the operation of one alternative embodiment of a packet switch as it recognizes a closing of a connection.

### DETAILED DESCRIPTION

Addressing is used to identify a node (e.g. a computer or a communications processor) on a computer network. Generally, each node attached to a network is identified by a logical address and a physical address. Physical addresses are often referred to as MAC (Media Access Control) addresses. One example form of a MAC address is written as xxx-xxx-xxx-xxx-xxx-xxx where each “xxx” entry is an integer ranging from 0 to 255. It should be appreciated that the number of MAC addresses available according to this example form exceeds 10²⁸, a very large number. It should also be appreciated that this example form of a physical address is presented as an illustration and is not intended to limit the scope of the appended claims. The logical address used by a node is not tied to any physical hardware. An Internet Protocol (IP) address is one example of a logical address. The scope of the appended claims is not intended to be limited to any particular form of logical address.

The physical address of a node is a unique hardware address assigned to a device when it is manufactured. When two computers need to communicate with each other, they normally identify each other using their respective logical addresses. The actual communication of data from one computer to another is accomplished using their corresponding physical (i.e. MAC) addresses. Accordingly, the infrastructure of a computer network provides mechanisms for discovering the association of a logical address to a physical address.

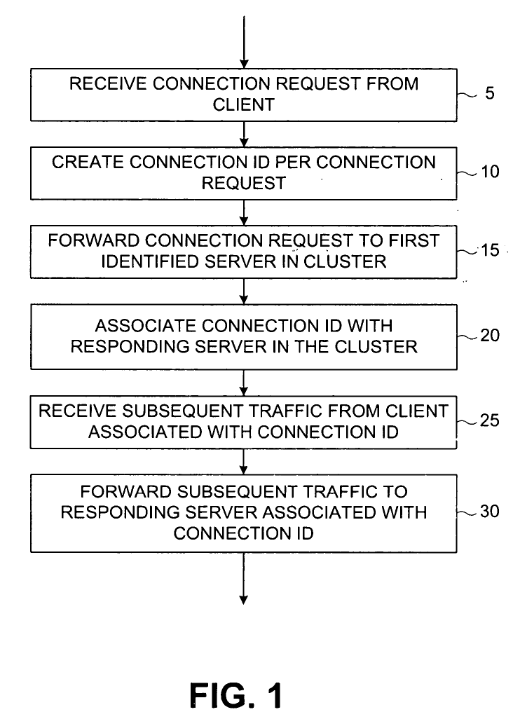

FIG. 1 is a flow diagram of a representative embodiment of a method for forwarding a data packet to a cluster of servers. According to this example method, a connection request is received from a client (step 5). After receiving a connection request, a connection identifier is formed according to the connection request (step 10). Once a connection identifier has been created, the connection request is forwarded to a first-identified server in the cluster of servers (step 15). When a response to the connection request is received from the cluster of servers, the connection identifier is associated with the server in the cluster of servers that transmitted the response (step 20). Subsequently, additional traffic associated with the connection identifier is received from the client (step 25). This subsequent traffic is forwarded to the responding server now associated with the connection identifier (step 30). The present method may be applied where a data packet is received from a computer network. This method may also be applied where a data packet is received from a computer network that is governed by the Transport Control Protocol (TCP) using Internet Protocol (IP) logical addressing. The present method may also be applied to other computer networks that are governed by other network protocols, including but not limited to X.25, Point-to-Point Protocol (PPP), ATM, OSI TP4, Stream Control Transmission Protocol (SCTP), and the like.

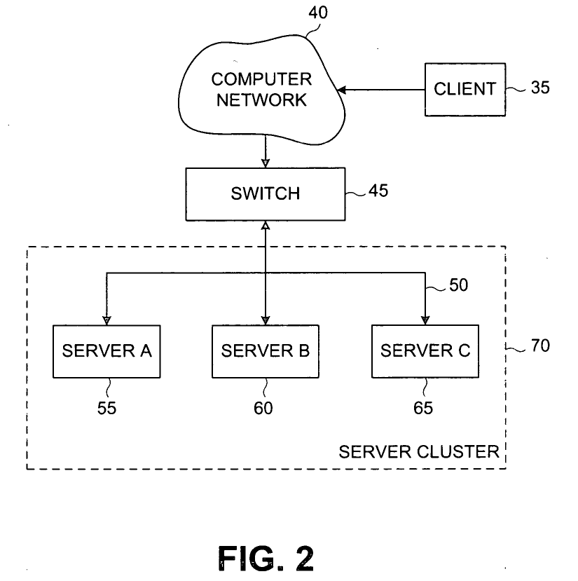

FIG. 2 is a block diagram that illustrates one example application of one example method for forwarding a data packet to a cluster of servers. The present method is applicable, according to one illustrative use case, in a system comprising a client computer 35 that connects to a first computer network 40. One example of a computer network is the Internet. According to this illustrative use case, Server A 55, Server B 60, and Server C 65 are organized as a cluster of servers 70. The cluster of servers 70 is connected to the first computer network 40 through a device referred to as a switch 45. The cluster of servers 70 is connected to the switch 45 using a second computer network 50. According to another illustrative variation of the present method, the cluster of servers 70 is connected to the first computer network 40 using an alternative connection device including at least one of a router, a bridge and a gateway. Each of these alternative connection devices is presented here only for purposes of illustration, and this enumeration of alternative connection devices in not intended to limit the scope of the appended claims. It should be further noted that the cluster of servers 70 can include two or more servers and the illustrative use case with three servers is presented here for illustration and is not intended to limit the scope of the appended claims.

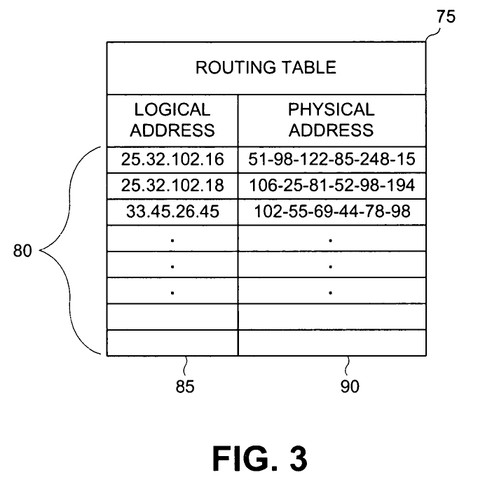

FIG. 3 is a pictorial diagram of a representative embodiment of a routing table. According to this example embodiment, a routing table 75 comprises one or more records 80 wherein each record includes a logical address 85 and a corresponding physical address 90 for each server in the cluster 70 attached to the switch 45. It should be understood that the content of a routing table 75 could change from time to time as new servers are added to or removed from the cluster 70. It should be noted that the various logical and physical addresses appearing in the figure are presented for illustrative purposes only and are not intended to limit the scope of the appended claims.

Given that each server in the server cluster 70 is identified by a logical address, the switch 45 uses the routing table 75 to direct a data packet to one of the servers in the server cluster 70. The client computer 35 directs a data packet to a server using a logical address (e.g. an IP address), and not the physical address (i.e. MAC address) of the destination (e.g. server) computer. The client computer 35 is generally not aware that the data packet is directed to a cluster of servers 70. Rather, the client computer 35 is typically only aware of one logical address of a server in the cluster 70. This server is known as a “doorkeeper”.

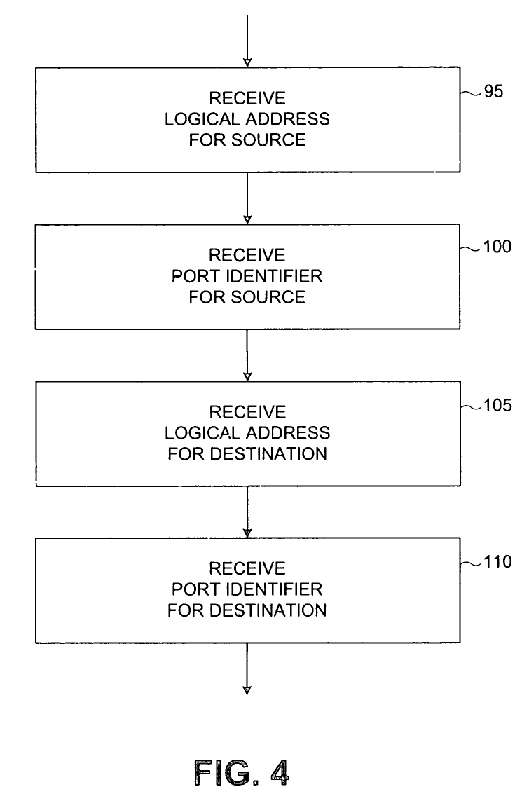

FIG. 4 is a flow diagram that depicts two alternative methods for receiving a connection request. According to one alternative method, a connection request is received by receiving a logical address for a source node (step 95) and a destination node (step 105). Typically, the source node is a client computer 35 and the destination node is a server (e.g. a doorkeeper) in a cluster 70. According to yet another alternative method, a connection request is received by optionally receiving a port identifier for the source node (step 100) and a port identifier for the destination node (step 110). According to one variation of the present method that is applicable where a connection request is received from a computer network using the TCP/IP protocol, a connection request is received in the form of an IP address and a port number for a source node and an IP address and a port number for a destination node. According to one alternative variation of the present method, a connection request is received in the form of a TCP packet with its SYN bit set.

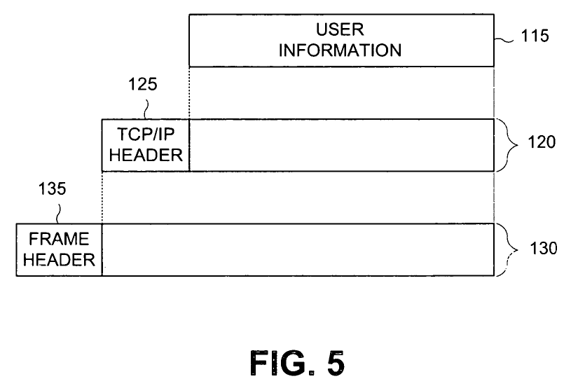

FIG. 5 is a pictorial diagram that illustrates an example nested structure for a connection request conforming to the TCP/IP protocol. When creating a connection identifier for a connection request conforming to the TCP/IP protocol, one alternative method comprises creating a 4-tuple that includes an IP address for a source node, a port number for the source node, an IP address for a destination node and a port number for the destination node. When the present method is used to receive a connection request from a TCP/IP network, the connection request includes user information 115 and a “request-from-client” encapsulated in a TCP packet 120. The TCP packet 120 includes in a TCP/IP header 125 a logical address (e.g. an IP address) of a destination computer (e.g. a server in the cluster 70 of FIG. 2).

FIG. 2 can be used to illustrate that a client computer 35 conveys the request-from-client to the first computer network 40. The first computer network 40 makes the TCP packet available to the switch 45. The switch 45 receives the TCP packet. In order to deliver the TCP packet to its final destination, the switch 45 looks up the logical address 85 (e.g. an IP address) of the destination computer in a routing table 75 stored in the switch 45 and retrieves the corresponding physical 90 (i.e. MAC) address of the destination computer. The switch 45 then encapsulates the TCP packet 120 (including the request-from-client) in a frame 130 having a frame header 135. The frame header 135 includes the physical address of the destination computer. The frame 70 is received by the destination computer (e.g. Server B 25 in one illustrative use case). A connection request packet, as defined by the TCP/IP protocol, typically comprises a code field with a SYN bit set. Again, this description is applicable to the situation where a connection is established using TCP/IP as a protocol, but variations to this situation are intended to be included in the scope of the appended claims because the present method and apparatus are applicable to a server cluster irrespective of the protocol used to establish a connection between a client and a server.

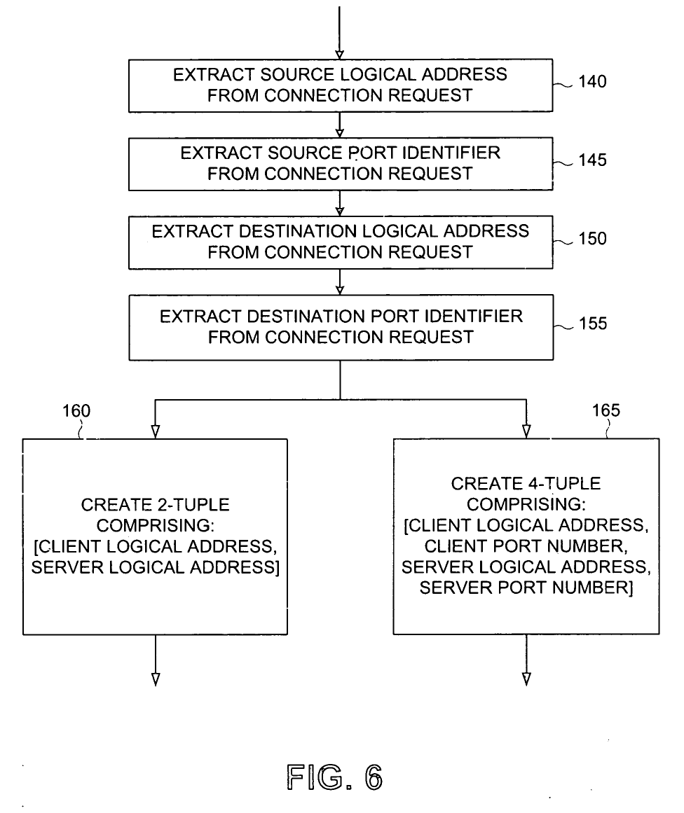

FIG. 6 is a flow diagram of a representative embodiment of a method for creating a connection identifier. A connection identifier, according to one variation of the present method, is created by forming an “n-tuple”. In general, the term “n-tuple” is used to refer to a collection of “n” numbers. According to one variation of the present method where a connection request is received in the form of a logical address for a source and destination node, the logical address of the source node and the logical address of the destination node are extracted (steps 140 and 150) from the connection request. A 2-tuple is formed (step 160) that includes the logical addresses extracted from the connection request. It should be noted when a request for a connection is received, the source node is the client computer 35 and the destination node is a server in the cluster 70 (e.g. a doorkeeper server). In the case where a connection request further comprises port identifier for the source and destination nodes, the source port identifier and the destination port identifier are extracted from the connection request (step 145 and 155). According to this variation of the present method, a 4-tuple is formed (step 165) that includes the logical addresses and port identifiers extracted from the connection request.

When a server in the cluster 70 responds to a connection request, a variation of the method described supra is used to create a connection identifier. According to this variation of the present method, a connection identifier is created by transposing the source and destination addresses (and optional port identifiers) included in the servers response. This alternative method is used when the response transmitted by the server identifies the server as the source node and the client as the destination node.

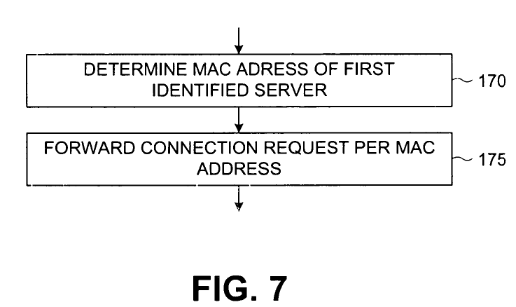

FIG. 7 is a flow diagram of a representative example method for forwarding a connection request to a first-identified server. According to one exemplary variation of this method, a physical (i.e. MAC) address of a first-identified server is determined (step 170). The connection request is forwarded to a server in a cluster 70 according to the physical address (step 175). According to one variation of the present method, a physical address for the first identified server is determined by consulting a routing table 75 (cf. discussion of FIGS. 2 and 3 supra). Where the present method is applied in a situation where a connection request conforms to the TCP/IP protocol, the logical destination IP address is converted to a physical MAC address.

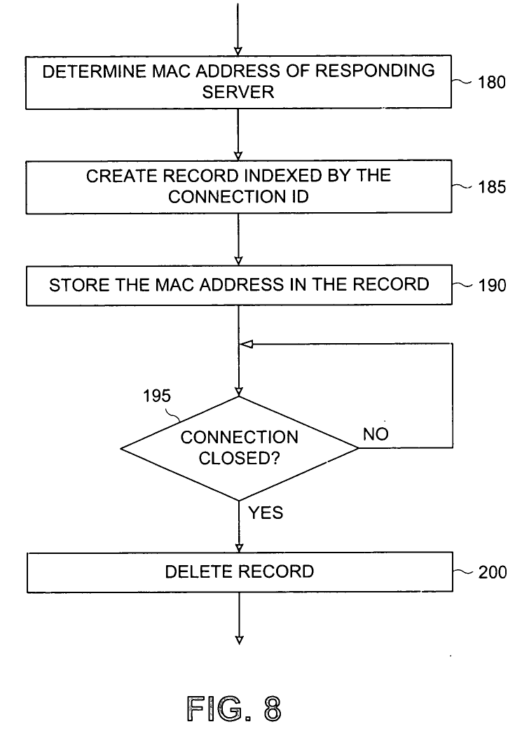

FIG. 8 is a flow diagram of a representative embodiment of a method for associating a connection identifier with a responding server. According to this exemplary variation of the present method, a connection identifier is associated with a responding server when the physical (i.e. MAC) address of the responding server is determined (step 180). A record is created and indexed according to the connection identifier (step 185) and the physical address is stored in the record (step 190). According to one illustrative variation of the method, a partial record comprising the connection identifier as an index is created when the connection request is received. When a response having the same connection identifier is received, the physical address of the server that transmitted the response is extracted from the response. The record then is completed by storing the physical address in the record indexed by the connection identifier. It should be noted that one variation of the present method relies on an alternative method for creating a connection identifier when a server is responding to a connection request. Accordingly, in this event, the connection identifier is formed by transposing the source and destination addresses (and optional port identifier) in the response.

According to one alternative variation of the present method, a record indexed by a connection identifier is deleted (step 200) from storage when the connection closes (step 195). One alternative variation of the present method is applicable when a TCP protocol is used to establish a connection. Typically, TCP employs a three-way handshake that can be initiated by either side to close a connection. That is, 1) the initiating side transmits a close connection request, 2) the opposite side transmits a close connection request with an ACK, and 3) the initiating side transmits an ACK after which the connection is closed. One alternative method provides for keeping track of TCP sequence numbers and a FIN flag in order to identify a matching close connection request. Once the connection is closed, the record indexed by the connection identifier is deleted.

According to another example variation of the present method that likewise supports the TCP protocol; a connection can be closed following a reset. A reset represents an abnormal termination of a TCP connection. For example, a server may initiate a reset condition after a client computer loses power and can no longer perform the normal operations necessary to maintain a TCP connection. A reset is signaled on the network by receipt of a connection reset packet. The connection reset packet can be transmitted from either side, but must be forwarded to the opposite side. If the reset packet is received from the client, then the reset packet is forwarded to the server. Conversely, if the reset packet is received from the server, then the reset packet is forwarded to the client. In either instance, once the reset packet has been forwarded, the record indexed by the connection identifier is deleted.

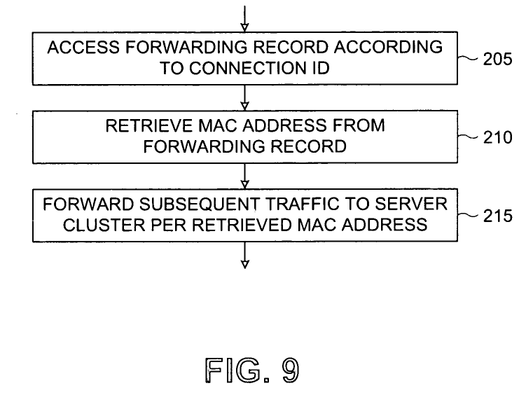

FIG. 9 is a flow diagram of a representative embodiment of a method for forwarding subsequent traffic to a responding server. According to this alternative variation of the present method, a forwarding record is accessed according to the connection identifier (step 205). In one exemplary embodiment, the record is indexed according to the connection identifier as described in the discussion of FIG. 8, supra. A physical address is retrieved from the forwarding record (step 160), and subsequent traffic is forwarded directly to a server in the cluster of servers according to the retrieved physical address (step 165). The retrieved physical address is the physical address that identifies the server that responded to the original connection request. It will be appreciated that forwarding the traffic directly to the responding server rather than routing the traffic through the doorkeeper server essentially eliminates the latency associated with such forwarding. Accordingly, the processing load on the doorkeeper server is reduced as well.

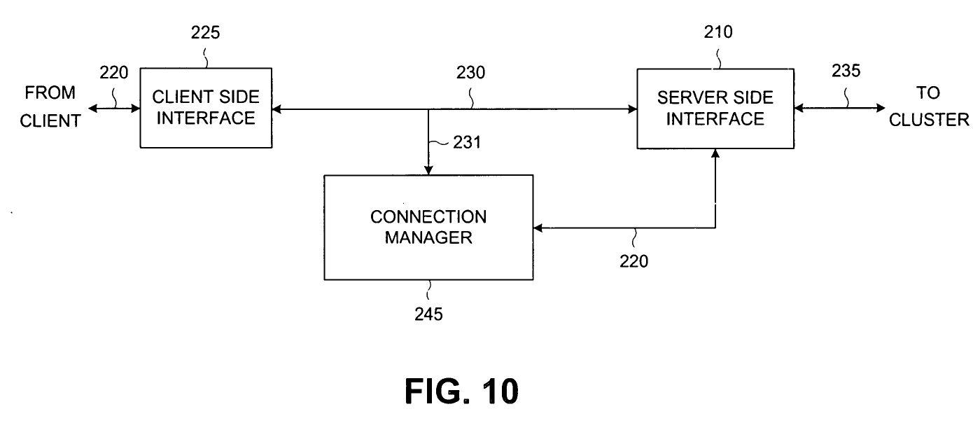

FIG. 10 is a block diagram of a representative embodiment of a data packet forwarding apparatus. According to this representative embodiment, an apparatus capable of forwarding data packets addressed to a cluster of servers comprises a client-side (C-S) interface 225, a server-side interface 210 and a connection manager 245. As the apparatus operates, the client-side interface 225 receives client-side traffic 220 comprising a connection request from a client. The server-side (S-S) interface 210 forwards 235 the connection request to a first-identified server in a cluster of servers. The connection manager 245 also receives the connection request 231. The connection manager 245 creates a connection identifier according to the connection request. The connection manager 245 monitors traffic received on the server side interface 210. When the connection manager perceives 220 a response to a connection request, it associates the connection identifier for the connection request with a responding server in the cluster of servers. The connection manager 245, according to one alternative embodiment, maintains the association between the connection identifier and the responding server for the duration of the connection. Subsequent client-side traffic 220 associated with the connection identifier is forwarded by the server-side interface 210 to a server according to an indicator 220. The indicator 220 is generated by the connection manager 245 according to the association it maintains between the connection identifier and the responding server.

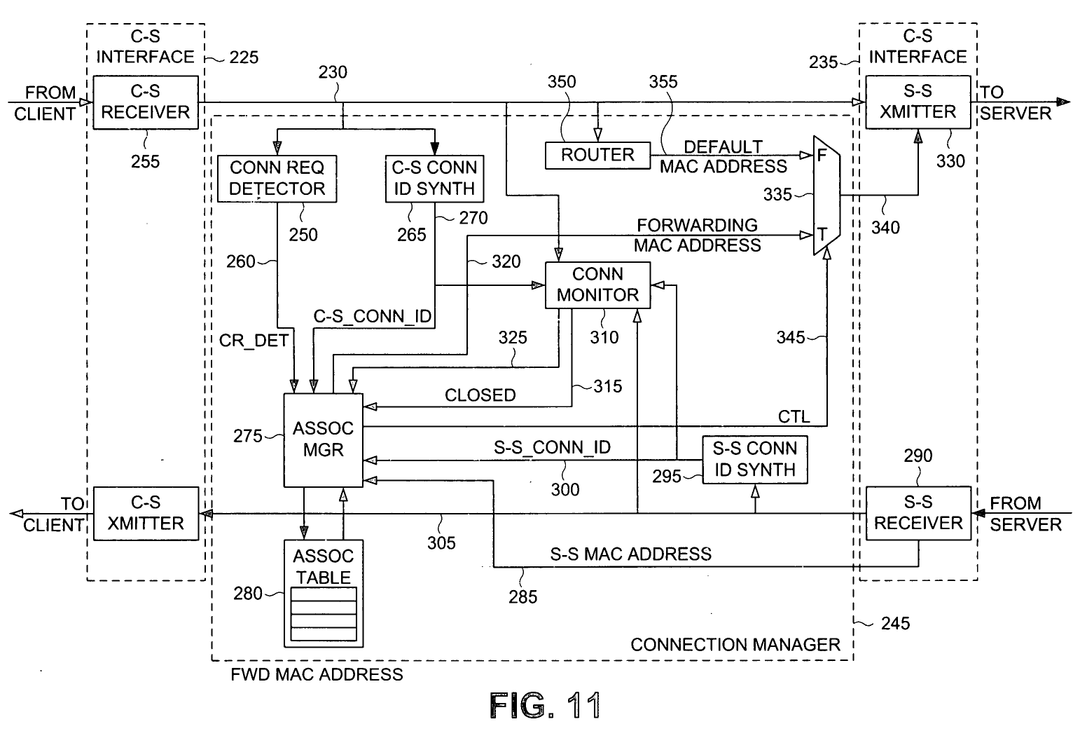

FIG. 11 is a block diagram of one alternative example embodiment of a connection manager. One example alternative embodiment of a connection manager 245 comprises a router 350 that receives traffic 230 and determines a default MAC address 355 according to a packet header included in the traffic 215. One illustrative embodiment of the router 350 comprises a routing table as described in the discussion of FIG. 3 supra. The router 350 extracts the logical address of a destination server (e.g. an IP address) from the received traffic and locates in a routing table a default MAC address 355 corresponding to the destination server's logical address. The logical address, for example, is extracted from a packet header where the traffic is formatted in accordance with the TCP/IP protocol. According to one illustrative embodiment, the router 350 passes the default MAC address 355 to an F input of a multiplexer 335 that further is included in the connection manager 245. The multiplexer 335 includes an output and two inputs; F input and T input. The output of the multiplexer 335 is selected to reflect either the F input or the T input to the multiplexer 335 according to the state of a control signal 345. The state of the control signal 345 is controlled by an association manager 275. The association manager 275 is also included in this example embodiment of a connection manager 245.

It should be noted that the output of the multiplexer 335 serves as a destination indicator 340 that includes a MAC address that directs traffic forwarded by a server-side transmitter 330 included in the server-side (S-S) interface 235. As described infra, the association manager 275 sets the control signal 345 to FALSE when the association manager 275 is not prepared to present a forwarding MAC address 320 to the T input of the multiplexer 335. When the control input 345 of the multiplexer is FALSE, the default MAC address 355 on the F input of the multiplexer 335 is presented at the multiplexer output. In the present instance, the default MAC address 355 is passed through the F input of the multiplexer 335 and emerges at the output of the multiplexer 335 as the destination indicator 340 to the server-side transmitter 330 included in the server-side interface 235. The destination indicator 340 comprises a physical address (i.e. the MAC address) of a destination server in the cluster. Hence, the server-side transmitter 330 forwards the traffic 230 to a server in a cluster of servers according to the MAC address included in the destination indicator 340. In particular, when the traffic 230 comprises a connection request, the connection request is forwarded to the server in the cluster of servers having a MAC address according to the destination indicator 340. This server is referred to as the first-identified server. Normally, the first-identified server is a doorkeeper, as introduced supra.

One alternative illustrative embodiment of the connection manager 245 comprises a connection request detector 250 that monitors packet traffic 230 received from a client-side (C-S) receiver 255. The client-side receiver 255 is included in the client-side interface 225. The connection request detector 250 sets a connection request detected signal, CR_DET 260 to TRUE when a received packet comprises a connection request. Another illustrative embodiment of the connection manager 245 further comprises a client-side connection identifier synthesizer 265 that extracts information from each packet in traffic 230 received from the client-side receiver 255 in order to form a connection identifier, C-S_CONN_ID 270 for each packet. Information extracted from each data packet and used as the basis for a connection identifier includes, but is not necessarily limited to one or more of a logical address of a source node, a port identifier for a source node, a logical address of a destination node and a port identifier for a destination node.

One alternative embodiment of the connection manager 245 comprises an association manager 275. The CR_DET signal 260 and the connection identifier (C-S_CONN_ID) 270 both are applied to inputs to the association manager 275. When the CR_DET signal 260 is TRUE, the association manager 275 accepts the connection identifier( C-S_CONN_ID) 270. The association manager 275 creates a record in an association table 280, using the value of C-S_CONN_ID 270 as an index. At this time, the record created in the association table 280 does not have stored within it a MAC address of an associated responding server, so the association manager 275 sets the control signal CTL 345 to FALSE.

The association manager 275 has presented at one of its inputs a MAC address 285 of any packet received by a server-side receiver 290. The server-side receiver 290 is included in the server-side interface 210 and receives server-side traffic 305 from servers in a cluster of servers. Server-side traffic 305 received by the server-side receiver 290 is monitored by a server-side connection identifier synthesizer 295. The server-side connection identifier synthesizer 295 extracts information from each packet received by the server-side interface 290 and creates a connection identifier (S-S_CONN_ID) 300 according to the extracted information. Information extracted from each data packet received by the server-side interface 290 and used as the basis for a connection identifier includes, but is not necessarily limited to one or more of a logical address of a source node, a port identifier for a source node, a logical address of a destination node and a port identifier for a destination node. It should be noted that one alternative embodiment of the connection identifier synthesizer 295 transposes logical addresses and port indicators to account for the fact that the server is the source node.

The server-side connection identifier S-S_CONN_ID 300 is presented at another input to the association manager 275. When the association manager 275 receives the server-side connection identifier, S-S_CONN_ID 300, the association manager 275 searches in the association table 280 for a record indexed by the value of S-S_CONN_ID 300. When a record is found having an index equal to the value of S-S_CONN_ID 300, then the association manager stores the MAC address 285 in the record having index equal to the value of S-S_CONN_ID 300. It should be understood that the index equal to the value of S-S_CONN_ID 300 is the index with value C-S_CONN_ID 270 previously stored in the association table 280. That is, S-S_CONN_ID 300 and C-S_CONN_ID 270 describe the same connection viewed, respectively, from the server side and the client side. The resulting record in the association table 280 has index equal to the connection identifier corresponding to the connection request previously received, and the record contains the MAC address of the responding server.

According to one alternative embodiment of the association manager 275, the association manager further is capable of detecting when a connection closes. According to one illustrative embodiment, the connection manager 245 further comprises a connection monitor 310 that receives client-side traffic 230 and server-side traffic 305. The connection monitor 310 further has presented at its inputs the client-side connection identifier, C-S_CONN_ID 270 and the server-side connection identifier, S-S_CONN_ID 300. When the connection monitor 310 observes a close connection request in the client-side traffic 215, the connection monitor 310 stores the value of the client-side connection ID, C-S_CONN_ID 270 and continues to monitor the server-side traffic 305. When the connection monitor 310 observes a close connection request in a packet having the same connection identifier in server-side traffic 215, the connection monitor 310 passes the connection identifier 325 to the association manager 275. The association manager 275 then deletes the entry in the association table 280 having index according to the received connection identifier 325.

According to one illustrative embodiment of the association manager 275, when the connection monitor 310 first observes a close connection request in the server-side traffic 305, then the connection monitor 310 proceeds as just described with the roles of the server-side and the client-side reversed. In either instance, the association manager 275 deletes the record in the association table 280 having index according to the connection identifier 325 received from the connection monitor 310.

According to another illustrative embodiment, the association manager 275 is capable of deleting a record in the association table 280 when a connection is reset. When the connection monitor 310 observes a connection reset packet in the client-side traffic 230, the connection monitor accepts the C-S_CONN_ID 270 input and passes the C-S_CONN_ID 270 as connection identifier 325 to the association manager 275 as before. Conversely, when the connection monitor 310 observes a connection reset packet in the server-side traffic 305, the connection monitor accepts the S-S_CONN_ID 300 input and passes the S-S_CONN_ID 300 as connection identifier 325 to the association manager 275. In either instance, the association manager 275 deletes the entry in the association table 280 having index according to the connection identifier 325 received from the connection monitor 310.

According to yet another alternative embodiment, the connection manager 245 further is capable of causing subsequent client-side traffic 230 associated with a connection identifier to be forwarded to a responding server in a cluster of servers. According to one exemplary mode of operation of this alternative embodiment, a packet is received in the client-side traffic 230. The client-side connection identifier synthesizer 265 generates a connection identifier according to information extracted from the received packet and presents the connection ID, C-S_CONN_ID 270 at an input to the association manager 275. The association manager 275 accepts the C-S_CONN_ID 270 input and searches in the association table 280 for a record having the value of C-S_CONN_ID 270 as its index. When such a record is found, the association manager 275 sets the control signal 345 to TRUE, retrieves a physical address from the record and presents this as a forwarding MAC address 320 to the T input of multiplexer 335. The forwarding MAC address 320 is passed by the multiplexer 335 to the server-side transmitter 330 as a destination indicator 340 comprising the forwarding MAC address. The server-side transmitter 330 forwards the client-side traffic 230 (e.g. a data packet) according to the MAC address included in the destination indicator 340.

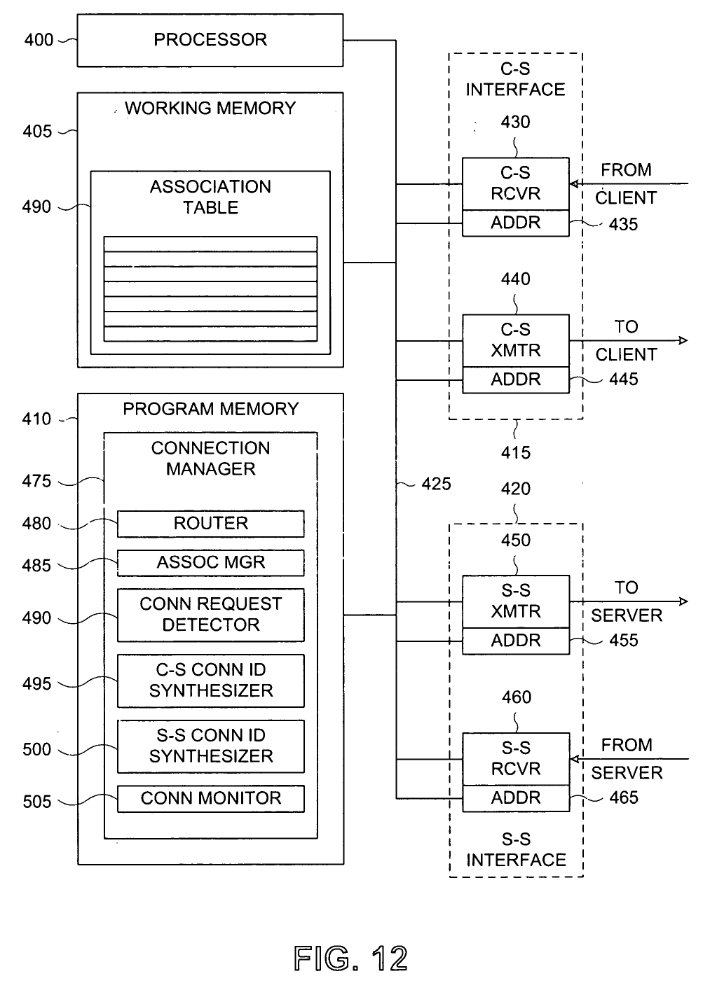

FIG. 12 is a block diagram of an exemplary embodiment of a packet network switch. This exemplary embodiment comprises a client-side (C-S) interface 415 capable of receiving a connection request from a client. This embodiment further comprises a server-side (S-S) interface 420 capable of forwarding the connection request to a first-identified server in a cluster of servers. This exemplary embodiment further comprises a working memory 405 capable of storing instructions and one or more processors 400 capable of executing the instruction sequences. This embodiment further comprises a program memory 410 wherein are stored one or more instruction sequences. A system bus 425 interconnects the aforementioned elements. This example embodiment includes a connection manager instruction sequence 475 stored in the program memory 410. The connection manager instruction sequence 475 comprises a router instruction sequence 480 and an association manager instruction sequence 485. It should be noted that the working memory 405 and the program memory can be combined into a single memory capable of serving as a working memory and a store for instruction sequences. Other memory configurations are also possible and the scope of the appended claims is intended to include all such variations in memory structure.

The operation of the packet network switch depicted in FIG. 12 is best described in terms of functional modules, each of which comprises an instruction sequence. For purposes of this disclosure, a functional module and its corresponding instruction sequence are referred to by a process name. The instruction sequence that implements the process name, according to one alternative embodiment, is stored in program memory 410. The reader is advised that the term “minimally causes the processor” and variants thereof is intended to serve as an open-ended enumeration of functions performed by the processor 400 as it executes a particular functional process (i.e. instruction sequence). As such, an embodiment where a particular functional process causes the processor 400 to perform functions in addition to those defined in the appended claims is to be included in the scope of the claims appended hereto.

The present exemplary embodiment of the packet network switch comprises a connection manager module 475 corresponding to the connection manager instruction sequence 475. As more particularly described infra, the processor 400, as it executes the connection manager module 475, minimally creates a connection identifier for a received connection request and associates the connection identifier with a responding server in a cluster of servers. The connection manager module 475 further causes the processor 400 to make information available to the server-side interface 420. This information enables the server side interface 420 to forward subsequent traffic associated with the connection identifier to a server according to an association maintained according to the connection manager instruction sequence. The connection manager module, according to one alternative embodiment, comprises a router module 480 and an association manager module 485. One illustrative embodiment of the packet network switch further comprises a connection request detector instruction sequence 490, a client-side connection identifier synthesizer instruction sequence 495, and a server-side connection identifier synthesizer instruction sequence 500. Another illustrative embodiment of the packet network switch still further comprises a connection monitor instruction sequence 505. Each of these instruction sequences, when executed by the processor 400 minimally cause the processor 400 to implement the functions of modules according to the respective instruction sequences. The functions of these modules are more particularly described infra.

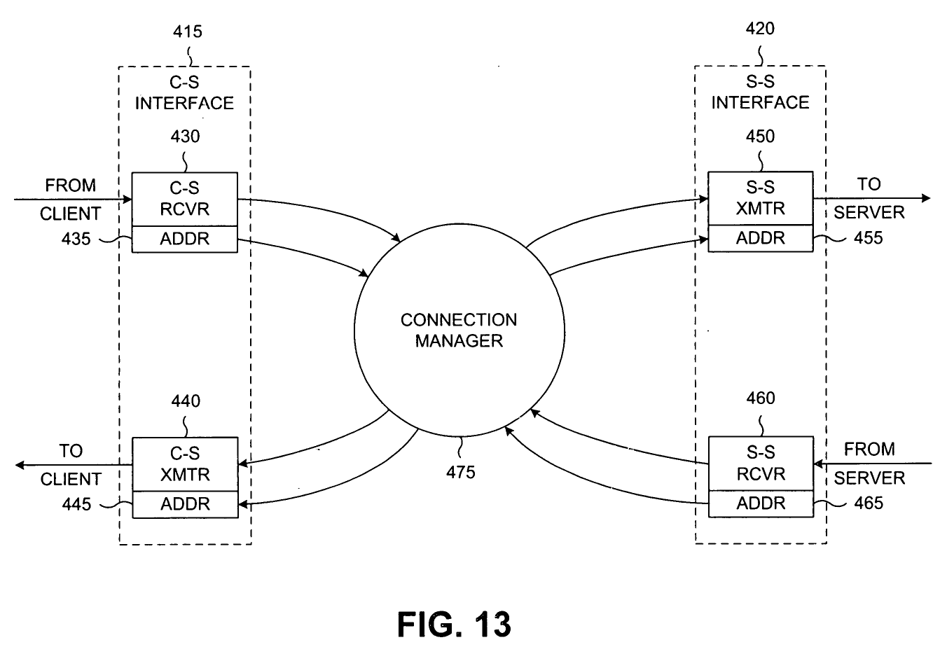

FIG. 13 is a data flow diagram that describes the interaction of functional modules according to one representative embodiment of a packet network switch. According to one illustrative embodiment of a packet network switch, the client-side (C-S) interface 415 comprises a client-side receiver 430 having associated therewith a MAC address register 435. The client-side receiver 430 comprises a client-side receive buffer accessible to the processor 400 wherein is stored a data packet received from a client. After a data packet is received, the MAC address register 435 included in the client-side receiver 430 has stored therein the MAC address of the device from which the client-side receiver 430 received the data packet. This address identifies the source node from whence the data packet arrived.

The server-side interface 420, according to the present representative embodiment, comprises a server-side receiver 460 having associated therewith a MAC address register 465. The server-side receiver 460 comprises a server-side receive buffer accessible to the processor 400 wherein is stored a data packet received from a server. After a data packet is received, the MAC address register 465 included in the server-side receiver 460 has stored therein the MAC address of the server from which the server-side receiver 460 received the data packet. It should be noted that the MAC address identifies a source node, noting that the source address is transposed with the destination address as described supra.

According to one illustrative embodiment, the connection manager module 575 is executed by the processor 400. When executed by the processor 400, the connection manager module 575 minimally causes the processor 400 to detect a data packet stored in the client-side receive buffer. The connection manager module 575 further minimally causes the processor 400 to identify a received data packet as a connection request and to create a connection identifier for the received connection request. According to further aspects of the operation of the packet network switch more particularly described infra, the server-side receiver 460 receives a response to the connection request. Executing the connection manager module 575 further minimally causes the processor 400 to identify a data packet stored in the server-side receive buffer as a response to the connection request. The connection manager module 575 still further minimally causes the processor 400 to retrieve the MAC address from the MAC address register 465 and to associate the connection identifier with the retrieved MAC address. The connection identifier is thus associated with the server in the cluster of servers that responded to the connection request.

The server-side interface 420, according to the present illustrative embodiment, further comprises a server-side transmitter 450 having associated therewith a MAC address register 455. The server-side transmitter 450 comprises a server-side transmit buffer accessible to the processor 400 wherein is stored a data packet to be transmitted to a server.

According to another illustrative mode of operation, the connection manager module 575, when executed by the processor 400, minimally causes the processor 400 to transfer a data packet from the client-side receive buffer of the client-side receiver 430 to the server-side transmit buffer of the server-side transmitter 450. The connection manager module 575, when executed by the processor 400, further minimally causes the processor 400 to store in the MAC address register 455 the MAC address of the server associated with the connection identifier of the data packet according to an association maintained by the connection manager module 475. The server-side transmitter 450 transmits a data packet in its server-side transmit buffer to a server according to the MAC address stored in the MAC address register 455.

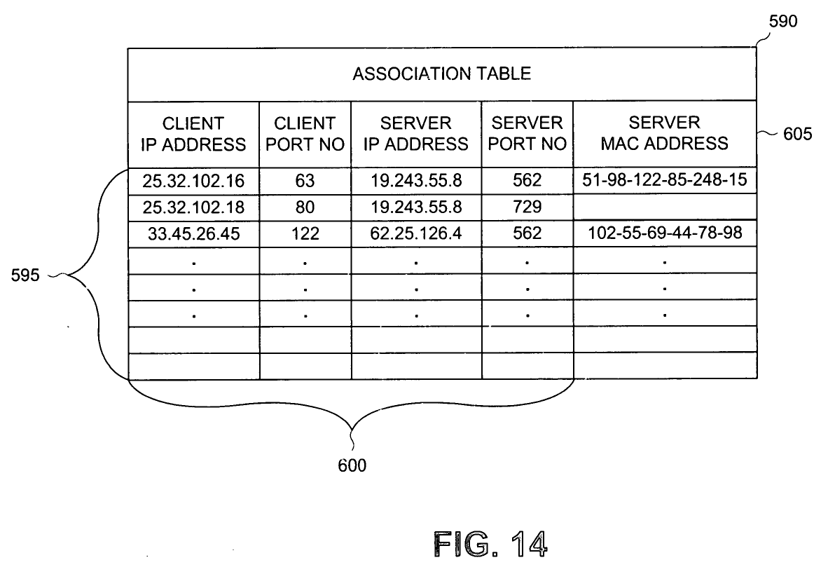

FIG. 14 is a pictorial diagram of a representative embodiment of an association table. According to this representative embodiment, an association table 590 can be used to store association information between a connection identifier and a forwarding physical (i.e. MAC address). This embodiment of an association table 590 can be used to store one or more records 595, each of which comprises an index 600. Each index 600, according to this illustrative example, corresponds to a connection identifier for a connection as described. For example, an index 600 comprises one or more of a source node logical address, a destination node logical address, a source port identifier and a destination port identifier as described supra. According to one example embodiment that is suitable for storing connection associations for connection requests conforming to the TCP/IP protocol, an index 600 comprises a client IP address and a server IP address. According to yet another embodiment, an index 600 further comprises client and server port numbers.

According to one typical mode of operation, a record comprising a connection identifier is created when a connection request is received from a client. When a response to the connection request is received from a responding server, the MAC address of the responding server is entered into the record. A subsequent data packet received from the client initiates a search in the association table 590 for a record having an index equal to the connection identifier of the received data packet. When such a record is found, a MAC address is extracted from the record, and the data packet is forwarded to the server having the extracted MAC address. It should be understood that each record 595 comprises a MAC address only when a response to the connection request has been received from a responding server. After a connection request has been received, but before a response has been received to the connection request, the record contains only a connection identifier as index.

In the present example, the first and third records in the table comprise MAC addresses. The MAC address field of the second record in the present example is blank indicating that, while a connection request has been transmitted to the cluster of servers, no response has yet been received from a server in the cluster of servers. The present example pertains to the TCP/IP protocol and, as such, is included only for the purpose of illustration. This illustrative example and the specific logical address, port numbers and MAC addresses that appear in the figure are not intended to limit the scope of the appended claims.

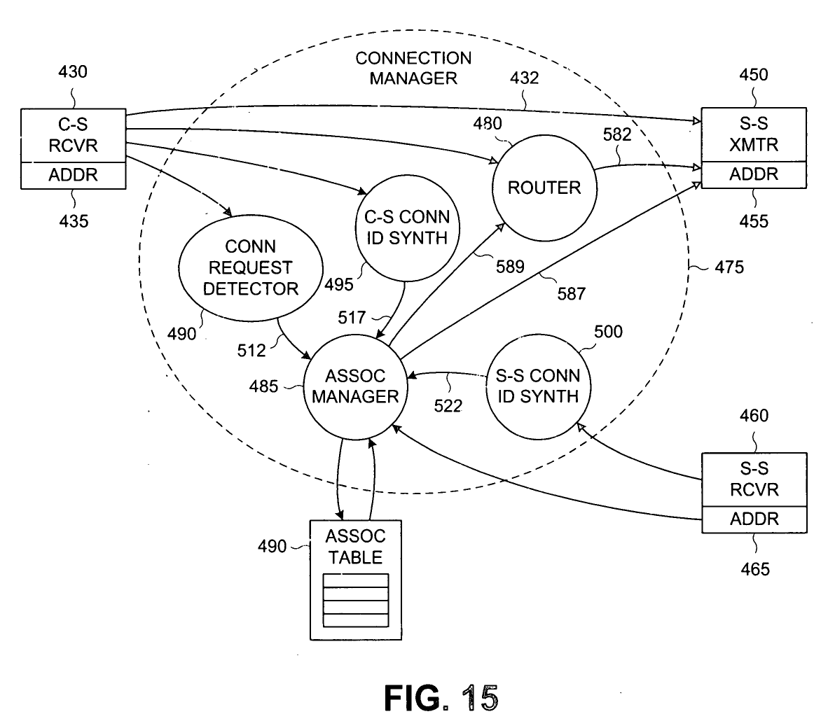

FIG. 15 is a data flow diagram that describes the operation of one alternative embodiment of a packet switch as it receives a connection request. The connection manager module 475, according to this alternative embodiment, comprises a router module 480, a connection request detector module 490, a client-side (C-S) connection identifier synthesizer module 495, a server-side (S-S) connection identifier synthesizer module 500 and an association manager module 485.

According to one exemplary mode of operation, the client-side receiver 430 receives a data packet from a client. The processor 400 executes the connection manager module 475 that minimally causes the processor 400 to detect the presence of a data packet in the client-side receive buffer of the client-side receiver 430. The processor 400 executes the connection request detector module 490 that minimally causes the processor 400 to detect a connection request. The processor 400 executes the router module 480. The router module 480, when executed by the processor 400, minimally causes the processor 400 to extract a destination logical address from a data packet supporting the connection request. The router module 480 further minimally causes the processor 400 to access a routing table and to retrieve a MAC address that corresponds to the extracted logical address. The retrieved MAC address is the MAC address of a first-identified server (i.e. the doorkeeper of the cluster of servers). The router module 480 further minimally causes the processor 400 to access the MAC address register 455 associated with the server-side transmitter 450 and to store the MAC address 582 of the first-identified server (i.e. the doorkeeper server in the cluster of servers) in the MAC address register 455. The server-side transmitter 450 receives into its server-side transmit buffer the connection request packet 432 located in the client-side receive buffer of the client-side receiver 430. The server-side transmitter 450 transmits the connection request packet according to the MAC address of the first-identified server.

According to another alternative embodiment of the packet network switch, the connection manager module 475 further comprises an association manager module 485 and a connection request detector module 490. The association manager module 485, when executed by the processor 400, minimally causes the processor 400 to associate a connection identifier with a responding server. According to one exemplary mode of operation, the client-side receiver 430 receives a connection request packet. The connection request packet is stored in the client-side receive buffer included in the client-side receiver 430. The connection request detector module 490, when executed by the processor 400, minimally causes the processor 400 to access the client-side receive buffer and to determine when a received data packet comprises a connection request. The connection request detector module 490 minimally causes the processor 400 to generate an indication 512 that a connection request has been received.

The processor 400 executes the client-side connection identifier synthesizer module 495. The client-side connection identifier synthesizer module 495, when executed by the processor 400, minimally causes the processor 400 to access the client-side receive buffer and to create a connection identifier according to the received connection request. The client-side connection identifier synthesizer module 495 further causes the processor 400 to generate an indication 517 comprising the connection identifier of the connection request. According to one illustrative embodiment, the client-side connection identifier synthesizer module 495 creates a connection identifier by extracting information including one or more of a source logical address, a destination logical address, a source port identifier and a destination port identifier from a data packet stored in the buffer included in the client-side receiver 430. One alternative embodiment of a client-side connection identifier synthesizer module 495, when executed by the processor 400, minimally causes the processor 400 to create a connection identifier that includes said extracted information.

The association manager module 485, when executed by the processor 400, minimally causes the processor 400 to receive the indication 512 that a connection request has been received and to receive the indication 517 comprising the connection identifier of the connection request. The association manager module 485 further minimally causes the processor 400 to create a record in an association table 490. The record is indexed by the connection identifier included in the indication 517 received from the client-side connection identifier synthesizer module 495. At this time the record created in the association table 590 does not include a MAC address of a server to which the connection request should be forwarded. The association manager module 485 therefore minimally causes the processor 400 generate a generate default MAC address command 589 and to execute the router module 480. The router module 480 minimally causes the processor 400 to receive the generate default MAC address command 589 and to respond to the command by determining a MAC address 582 for a first-identified server. The router module 480 further minimally causes the processor 400 to store the MAC address 582 in the MAC address register 455 of the server-side transmitter 450. Under direction of the processor 400, the server-side transmitter 450 receives the connection request 432 from the client-side receive buffer included in the client-side receiver 430 and forwards the connection request to the first-identified server according to the MAC address stored in the MAC address register 455.

When a response to the connection request is received by the server-side receiver 460, the response is stored in the server-side receive buffer associated with the server-side receiver 460. The MAC address of the server that transmitted the response is stored in the MAC address register 465 associated with the server-side receiver 460. When a data packet is received into the server-side receive buffer, the processor 400 executes the server-side connection identifier synthesizer module 500. The server-side connection identifier synthesizer module 500, when executed by the processor 400, minimally causes the processor 400 to access the data packet stored in the server-side receiver buffer of the server-side 460 and to extract there from information from that can be used to create a connection identifier. The server-side connection identifier synthesizer module 500 further minimally causes the processor 400 to generate an indication 522 comprising the server-side connection identifier. The processor 400 executes the association manager module 585. The association manager module 585 minimally causes the processor 400 to receive the indication 522 comprising the server-side connection identifier and to search the association table 490 for a record indexed by the same connection identifier. When the record is found, the association manger 485 further minimally causes the processor 400 to access the MAC address register 465 included in the server-side receiver 460 and to retrieve the MAC address of the responding server stored therein. The association manager module 485 further minimally causes the processor 400 to update the record in the association table 490 having an index equal to the just-received server-side connection identifier by storing the MAC address of the responding server in the record. It should be understood that the server-side connection identifier is identical the client-side connection identifier indexes the record in the association table 590 wherein is stored the MAC address of the responding server. This is accomplished by transposing the source and destination logical addresses (and option port identifiers).

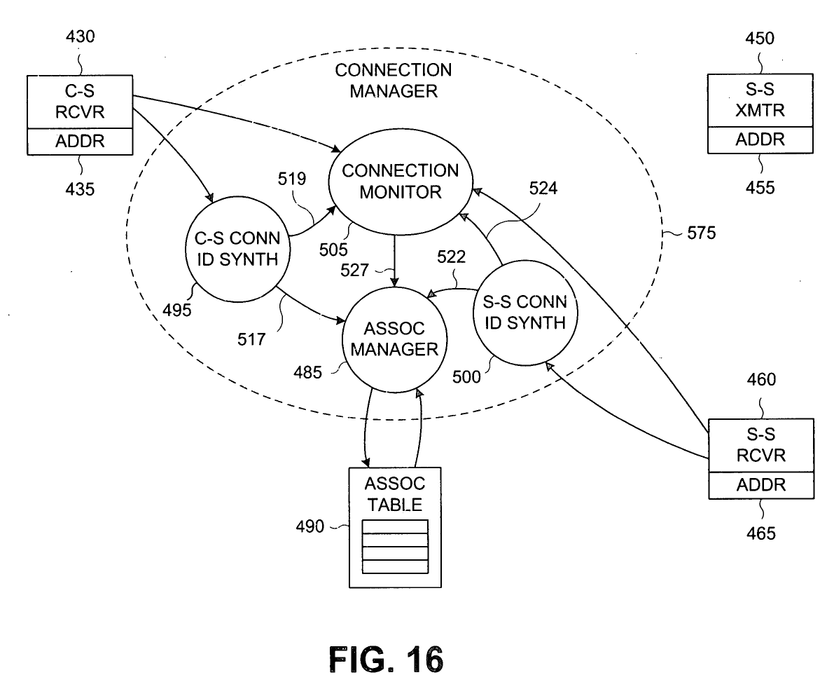

FIG. 16 is a data flow diagram that describes the operation of one alternative embodiment of a packet switch as it recognizes a closing of a connection. This alternative embodiment further comprises a connection monitor module 505 that is included in the connection manager module 475. The connection monitor module 505, when executed by the processor 400 minimally causes the processor 400 to delete a record of a closed connection from the association table 490.

According to one illustrative mode of operation that follows the TCP protocol, the processor 400 executes the connection monitor module 505. The connection monitor module 505, when executed by the processor 400, minimally causes the processor 400 to access a data packet received in the client-side receiver buffer of the client-side (C-S) receiver 430. The connection monitor module 505 further minimally causes the processor 400 to access a data packet received in the server-side receive buffer of the server-side (S-S) receiver 460. The connection monitor module 505 still further minimally causes the processor 400 to execute the client-side connection identifier synthesizer module 495. The client-side connection identifier synthesizer module 505 minimally causes the processor 400 to generate an indication 519 comprising a connection identifier for a data packet received from a client as previously described. The connection monitor module 505 further minimally causes the processor 400 to execute the server-side connection identifier synthesizer module 500. The server-side connection identifier synthesizer module 500, when executed by the processor 400 minimally causes the processor 400 to generate an indication 524 comprising a connection identifier for a data packet received from a server as previously described. The connection monitor module 505 even further minimally causes the processor 400 to detect a close connection request in a data packet header.

According to one example, the processor 400 executes the connection monitor module 505. The connection monitor module 505, when executed by the processor 400, minimally causes the processor 400 to detect a close connection request in a data packet received by the client-side receiver 430. The connection monitor module 505 further minimally causes the processor 400 to store the value of the client-side connection identifier 519 associated with the close connection request and to continue to monitor the data packets received by the server-side receiver 460. The connection monitor module 505 still further minimally causes the processor 400 to detect a close connection request in a data packet in the server-side receive buffer of the server-side receiver 460. When the processor 400 detects a close connection request in the data packet in the server-side receive buffer, the connection monitor module 505 minimally causes the processor 400 to compare the value of the server-side connection identifier 524 with the stored value of the client-side connection identifier 519. If the two connection identifiers match, then the connection monitor 505 causes the processor 400 to generate an indication 527 comprising the stored value of the client-side connection identifier 519 and further comprising a closed connection message. The processor 400 executes the association manager module 485 that minimally causes the processor 400 to receive the indication 527 comprising the connection identifier 519 and the closed connection message. The association manager module 485 further minimally causes the processor 400 to locate a record in the association table 490 having the connection identifier 519 as an index and to delete the record.

According to another example, the processor 400 executes the connection monitor module 505 that minimally causes the processor 400 to detect a close connection request in a data packet received by the server-side receiver 460. Operation proceeds in that instance in the manner just described except that the roles of client-side and server-side are reversed. In either instance, the processor 400 executes the association manager module 485 that, when executed by the processor 400, minimally causes the processor 400 to delete the record in the association table 490 having index according to the connection identifier 519.

One illustrative embodiment of the connection monitor module 505, when executed by the processor 400 further minimally causes the processor 400 to delete a record in the association table 590 for a connection that closes due to a reset. According to another illustrative mode of operation that follows the TCP protocol, the processor 400 executes the connection monitor module 505. The connection monitor module 505, when executed by the processor 400, further minimally causes the processor 400 to detect a connection reset packet. When the processor 400 detects a connection reset packet in the client-side receive buffer of the client-side receiver 430, the connection monitor 505 minimally causes the processor 400 to execute the client-side connection identifier synthesizer 495. The client-side connection identifier synthesizer 495 minimally causes the processor 400 to generate a client-side connection identifier from the connection reset packet and to generate an indication 519 according to the client-side connection identifier. The connection monitor module 505 further minimally causes the processor 400 to generate an indication 527 comprising the client-side connection identifier and further comprising a message indicating that the connection has been closed. The processor 400 executes the association manager module 485 that minimally causes the processor 400 to receive the indication 527 comprising the connection identifier 519 and the closed connection message. The association manager module 585 further minimally causes the processor 400 to locate the record in the association table 490 having the connection identifier 519 as an index and to delete the record.

Similarly, when the connection monitor module 505 causes the processor 400 to detect a connection reset packet in the server-side receive buffer of the server-side receiver 460, the connection monitor 505 causes the processor 400 to receive the server-side connection identifier 524. The processor 400 executes the association manager module 485 that minimally causes the processor 400 to receive the indication 527 comprising the connection identifier 519 and the closed connection message. The association manager module 485 further minimally causes the processor 400 to locate a record in the association table 490 having the connection identifier 524 as an index and to delete the record.

FIG. 15 further illustrates that, according to this exemplary embodiment, the connection manager module 475, when executed by the processor 400, further minimally causes subsequent traffic received by the client-side receiver 430 to be forwarded to the responding server in the cluster of servers. According to one illustrative mode of operation, a data packet is received in the client-side receiver buffer of the client-side receiver 430. The processor 400 executes the client-side connection identifier synthesizer 495 that, when executed by the processor 400, minimally causes the processor 400 to generate a client-side connection identifier from the received packet as described supra and to generate an indication 517 comprising the client-side connection identifier. The processor 400 executes the association manager module 485 that, when executed by the processor 400, further minimally causes the processor 400 to receive the indication 517 comprising the client-side connection identifier. The association manager module 485 further minimally causes the processor 400 to search in the association table 490 for a record having the value of the client-side connection identifier as an index. When the record is found, the association manager module 485 minimally causes the processor 400 to retrieve a forwarding MAC address from the record and to pass the MAC address 587 to the MAC address register 455 associated with the server-side transmitter 450. The server-side transmitter 450 receives the data packet 432 from the client-side receiver 430 and forwards the data packet 432 to the responding server according to the MAC address 587.

The functional modules (and their corresponding instruction sequences) described herein that enable forwarding of data packets to a cluster of servers are, according to one alternative embodiment, imparted onto a computer readable medium. Examples of such media include, but are not limited to, random access memory, read-only memory (ROM), CD ROM, floppy disks, and magnetic tape. This computer readable medium, which alone or in combination can constitute a stand-alone product, can be used to convert a general-purpose computing platform comprising a client-side network interface and a server-side network interface into a device for forwarding data packets according to the techniques and teachings presented herein.

While these methods and apparatus have been described in terms of several alternative methods and exemplary embodiments, it is contemplated that alternatives, modifications, permutations, and equivalents thereof will be included in the scope of the appended claims.

1. A method for forwarding a data packet addressed to a cluster of servers comprising:
receiving a connection request from a client;
creating a connection identifier according to the connection request;
forwarding the connection request to a first identified server in the cluster of servers;
associating the connection identifier with a responding server in the cluster of servers;
receiving subsequent traffic from the client associated with the connection identifier;
forwarding the subsequent traffic to the responding server associated with the connection identifier.

2. The method of claim 1 wherein forwarding the connection request to a first identified server comprises:
determining a physical address of the first identified server; and
forwarding the connection request according to the physical address.

3. The method of claim 1 wherein associating a connection identifier with a responding server comprises:
determining a physical address of the responding server;
creating a record indexed by the connection identifier; and
storing the physical address in the record.

4. The method of claim 3 further comprising deleting the record indexed by the connection identifier when the connection closes.

5. The method of claim 1 wherein forwarding the subsequent traffic to the responding server comprises:
accessing a forwarding record according to the connection identifier;
retrieving a physical address from the forwarding record; and
forwarding the subsequent traffic to a server in the cluster of servers according to the retrieved physical address.

6. The method of claim 1 wherein creating a connection identifier comprises:
extracting a client Internet Protocol address from the connection request;
extracting a client port number from the connection request;
extracting a server Internet Protocol address from the connection request;
extracting a server port number from the connection request; and
creating a 4-tuple comprising:
the client Internet Protocol address;
the client port number;
the server Internet Protocol address; and
the server port number.

7. An apparatus capable of forwarding a data packet addressed to a cluster of servers comprising:
client side interface capable of receiving a connection request from a client;
server side interface capable of forwarding the connection request to a first identified server in the cluster of servers;
connection manager capable of creating a connection identifier for the received connection request and associating the connection identifier with a responding server in the cluster of servers and wherein the server side interface is further capable of forwarding subsequent traffic associated with the connection identifier to a server according to an association maintained by the connection manager.

8. The apparatus of claim 7 wherein the connection manager comprises a router capable of:
determining a media access control address of the first identified server; and
making the media access control address available to the server side interface.

9. The apparatus of claim 7 wherein the connection manager comprises an association manager capable of:
determining a media access control address of the responding server;
creating a record indexed by the connection identifier; and
storing the media access control address in the record.

10. The apparatus of claim 9 wherein the association manager further is capable of deleting the record indexed by the connection identifier when the connection closes.

11. The apparatus of claim 7 wherein the connection manager further is capable of:
accessing a forwarding record according to the connection identifier;
retrieving a media access control address from the forwarding record; and
making the retrieved media access control address available to the server side interface wherein the server side interface is capable of forwarding the subsequent traffic associated with the connection identifier to a server in the cluster of servers according to the retrieved media access control address.

12. The apparatus of claim 7 wherein the connection manager is capable of:
extracting a client Internet Protocol address from the connection request;
extracting a client port number from the connection request;
extracting a server Internet Protocol address from the connection request;
extracting a server port number from the connection request; and
creating a 4-tuple comprising:
the client Internet Protocol address;
the client port number;
the server Internet Protocol address; and
the server port number.

13. A packet network switch comprising:
client side interface capable of receiving a connection request from a client;
server side interface capable of forwarding the connection request to a first identified server in a cluster of servers;
memory capable of storing instructions;
processor capable of executing instruction sequences stored in the memory;
connection manager instruction sequence stored in the memory that, when executed by the processor, minimally causes the processor to:
create a connection identifier for the received connection request;
associate the connection identifier with a responding server in the cluster of servers;
make information available to the server side interface that enables the server side interface to forward subsequent traffic associated with the connection identifier to a server according to an association maintained by the processor according to the connection manager instruction sequence.

14. The packet network switch of claim 13 wherein the connection manager instruction sequence comprises a router instruction sequence that causes the processor to forward a connection request to a first identified server by minimally causing the processor to:
determine a media access control address of the first identified server; and
make the media access control address available to the server side interface.

15. The packet network switch of claim 13 wherein the connection manager instruction sequence comprises an association manager instruction sequence that causes the processor to associate a connection identifier with a responding server by minimally causing the processor to:
determine a media access control address of the responding server;
create a record indexed by the connection identifier; and
store the media access control address in the record.

16. The packet network switch of claim 15 wherein the association manager instruction sequence further minimally causes the processor to delete the record indexed by the connection identifier when the connection closes.

17. The packet network switch of claim 13 wherein the connection manager instruction sequence comprises an association manager instruction sequence that, when executed by the processor, minimally causes the processor to make information available to the server side interface that enables the server side interface to forward subsequent traffic associated with the connection identifier to a server according to an association maintained by the processor according to the connection manager instruction sequence by minimally causing the processor to:
access a forwarding record according to the connection identifier;
retrieve a media access control address from the forwarding record; and
make the retrieved media access control address available to the server side interface wherein the server side interface is capable of forwarding the subsequent traffic associated with the connection identifier to a server in the cluster of servers according to the retrieved media access control address.

18. The packet network switch of claim 13 wherein the connection manager instruction sequence comprises a connection identifier synthesizer instruction sequence that, when executed by the processor, minimally causes the processor to create a connection identifier according to the connection request by minimally causing the processor to:
extract a client Internet Protocol address from the connection request;
extract a client port number from the connection request;
extract a server Internet Protocol address from the connection request;
extract a server port number from the connection request; and
create a 4-tuple comprising:
the client Internet Protocol address;
the client port number;
the server Internet Protocol address; and
the server port number.

19. A computer-readable medium having functions executable by a computer, said computer comprising a client-side network interface and a server-side network interface, said functions comprising functions for forwarding a data packet to a cluster of servers comprising:
connection manager instruction sequence that, when executed by a processor, minimally causes the processor to:
receive a connection request from a client;
create a connection identifier according to the connection request;
associate the connection identifier with a responding server in the cluster of servers;
make information available to the server side interface that enables the server side interface to forward subsequent traffic from the client associated with the connection identifier to a server according to an association maintained by the processor according to the connection manager instruction sequence.

20. The computer-readable medium of claim 19 wherein the connection manager instruction sequence comprises a router instruction sequence that causes the processor to forward a connection request from a client to a first identified server by minimally causing the processor to:
determine a media access control address of the first identified server; and
make the media access control address available to the server side interface.

21. The computer-readable medium of claim 19 wherein the connection manager instruction sequence comprises an association manager instruction sequence that causes the processor to associate a connection identifier with a responding server by minimally causing the processor to:
determine a media access control address of a responding server;
create a record indexed by the connection identifier; and
store the media access control address in the record.

22. The computer-readable medium of claim 21 wherein the association manager instruction sequence further minimally causes the processor to delete the record indexed by the connection identifier when the connection closes.

23. The computer-readable medium of claim 19 wherein the connection manager instruction sequence comprises an association manager instruction sequence that, when executed by the processor, minimally causes the processor to forward subsequent traffic associated with the connection identifier to a server according to an association maintained by the processor according to the connection manager instruction sequence by minimally causing the processor to:
access a forwarding record according to the connection identifier;
retrieve a media access control address from the forwarding record; and
make the retrieved media access control address available to the server side interface wherein the server side interface is capable of forwarding the subsequent traffic associated with the connection identifier to a server in the cluster of servers according to the retrieved media access control address.

24. The computer-readable medium of claim 19 wherein the connection manager instruction sequence comprises a connection identifier synthesizer instruction sequence that, when executed by the processor, minimally causes the processor to create a connection identifier according to the connection request by minimally causing the processor to:
extract a client Internet Protocol address from the connection request;
extract a client port number from the connection request;
extract a server Internet Protocol address from the connection request;
extract a server port number from the connection request; and
create a 4-tuple comprising:
the client Internet Protocol address;
the client port number;
the server Internet Protocol address; and
the server port number.

25. A packet network forwarding apparatus for forwarding a data packet addressed to a cluster of servers comprising:
means for receiving a connection request from a client;
means for creating a connection identifier according to the connection request;
means for forwarding the connection request to a first identified server in the cluster of servers;
means for associating the connection identifier with a responding server in the cluster of servers;
means for receiving subsequent traffic from the client associated with the connection identifier;
means for forwarding the subsequent traffic to the responding server associated with the connection identifier.

26. The packet network forwarding apparatus of claim 25 wherein the means for forwarding the connection request comprises:
means for determining a media access control address of the first identified server; and
means for forwarding the connection request according to the media access control address.

27. The packet network forwarding apparatus of claim 25 wherein the associating means comprises:
means for determining a media access control address of the responding server;
means for creating a record indexed by the connection identifier; and
means for storing the media access control address in the record.

28. The packet network forwarding apparatus of claim 27 further comprising means for deleting the record indexed by the connection identifier when the connection closes.

29. The packet network forwarding apparatus of claim 25 wherein the means for forwarding the subsequent traffic comprises:
means for accessing a forwarding record according to the connection identifier;
means for retrieving a media access control address from the forwarding record; and
means for forwarding the subsequent traffic to a server in the cluster of servers according to the retrieved media access control address.

30. The packet network forwarding apparatus of claim 25 wherein the connection identifier creating means comprises:
means for extracting a client Internet Protocol address from the connection request;
means for extracting a client port number from the connection request;
means for extracting a server Internet Protocol address from the connection request;
means for extracting a server port number from the connection request; and
means for creating a 4-tuple comprising:
the client Internet Protocol address;
the client port number;
the server Internet Protocol address; and
the server port number.

31. A method for forwarding a data packet to a cluster of severs comprising:
receiving from a client a connection request, wherein the connection request comprises one or more data packets addressed to a cluster of servers;
forwarding the one or more data packets to the cluster of servers;
determining the media access control address of a server responding to the one or more connection request data packets; and
directing a subsequently received data packet pertaining to a connection resulting from the connection request to a server according to the determined the media access control address.
